(19) United States
(12) Patent Application Publication
(10) Pub. No.: US 2022/0089937 A1
(43) Pub. Date: Mar. 24, 2022

(54) POLYOXOPOLYAMINE DESORBENTS FOR ENHANCED OIL RECOVERY

(71) Applicants: RHODIA OPERATIONS, Aubervilliers (FR); IFP Energies Nouvelles, Rueil-Malmaison (FR)

(72) Inventors: Mikel Morvan, Pessac (FR); Max Chabert, Singapore (SG); Sayak Roy, Singapore (SG)

(73) Assignees: RHODIA OPERATIONS, Aubervilliers (FR); IFP Energies Nouvelles, Rueil-Malmaison (FR)

(21) Appl. No.: 17/416,981

(22) PCT Filed: Dec. 18, 2019
(86) PCT No.: PCT/EP2019/086008

§ 371 Date: Jun. 21, 2021

(30) Foreign Application Priority Data
Dec. 20, 2018 (EP) 18214419.6

(51) Int. Cl. C09K 8/588; C09K 8/584

(52) U.S. Cl. CPC C09K 8/588; C09K 8/584

(57) ABSTRACT

The instant invention concerns the use of a compound of formula

R¹R²N—(CH₂)ₘ−NR³—(CH₂)_{m′}−NR⁴R⁵

wherein each of m and m′ is 1, 2, 3 or 4; and each of R¹, R², R³, R⁴ and R⁵ is a group of formula —[O—CH₂—CH(—CH₃)—]ₙ—[O—CH₂—CH₂]ₚ—OH, wherein n is from 2 to 30; and p is from 5 to 50

for decreasing or inhibiting the anionic-surfactant retention phenomena in an oil reservoir.

### CROSS-REFERENCE TO RELATED APPLICATION

The present application is a national stage of PCT Application No. PCT/EP2019/086008 filed on Dec. 18, 2019, which is herein incorporated by reference.

### TECHNICAL FIELD

The instant invention relates to the field of the enhanced recovery of crude oil from underground formations, and more particularly to the problems of retention of surfactants in these underground formations during steps of enhanced oil recovery.

### BACKGROUND

During the extraction of oil from a hydrocarbon reservoir (oil-yielding reservoir such as a consolidated or non-consolidated rock formation, or a sand, for example), according to a first step known as “primary recovery”, the oil is entrained out of a production well by the excess pressure naturally prevailing in the reservoir. This primary recovery gives access to only a small amount of the oil contained in the reservoir, typically at the very most about 10% to 15%.

In order to enable the extraction of the oil to continue after this primary recovery, secondary production methods are employed, when the pressure in the reservoir becomes insufficient to displace the oil that is still in place. Typically, a fluid is injected (reinjection of the diluted or undiluted water produced, injection of sea or river water, or alternatively injection of gas, for example) into the hydrocarbon reservoir, in order to exert in the reservoir an excess pressure capable of entraining the oil toward the production well(s). A usual technique in this context is injection of water (also known as waterflooding), in which large volumes of water are injected under pressure into the reservoir via injection wells. The injected water entrains part of the oil that it encounters and pushes it toward one or more production wells. However, secondary production methods such as waterflooding make it possible to extract only a relatively small part of the hydrocarbons in place (typically about 30%). This partial flushing is due especially to the trapping of the oil by the capillary forces, to the differences in viscosity and density existing between the injected fluid and the hydrocarbons in place, and also to heterogeneities at microscopic or macroscopic scales (at the scale of the pores and also at the scale of the reservoir).

In order to attempt to recover the rest of the oil which remains in the underground formations after the use of the primary and secondary production methods, various techniques have been proposed, which are known as Enhanced Oil Recovery (EOR). Among these techniques, mention may be made of techniques similar to the above mentioned waterflooding, but using a water comprising additives, for instance water-soluble surfactants (this is then typically referred to as surfactant flooding). The use of such surfactants especially induces a decrease in the water/oil interfacial tension (IFT), which is capable of ensuring more efficient entrainment of the oil trapped in the pore constrictions.

Typically in the methods of surfactant flooding, one or more water soluble surfactant formulation is injected with large volume of injection water into the hydrocarbon reservoir to lower the IFT between oil and water. The surfactants usually recommended in this context are typically anionic surfactants, especially of sulfate, sulfonate or carboxylate type.

Although they do indeed prove to be effective in lowering the water/oil interface tension, these anionic surfactants have a drawback, namely they tend to remain trapped in the underground formations, typically due to chemical absorption phenomena at the surface of the rocks which affects the recovery efficacy and/or the process costs.

Among other issues, the surfactants that are immobilized in the reservoir can no longer participate in the mobilization and extraction of the oil, and the extraction efficacy is consequently affected. Strong adsorption may be compensated for by the use of high concentrations of surfactants, but with not negligible repercussions in terms of costs. More generally, the surfactant adsorption phenomena results on a loss that has a negative impact on the extraction costs, which can make a process economically unfeasible.

The adsorption phenomena of the anionic surfactants are especially high:
when the surfactants are used in a water with high contents of salt and/or of divalent cations (especially seawater); and
in certain rock formations, such as carbonates or clay rocks such as argillaceous sandstones (in which the adsorption is high, even if waters with high contents of salt and/or of divalent ions are avoided).

In order to inhibit the surfactant adsorption, various solutions have been proposed, which are more or less effective and which are generally limited to specific conditions of use.

Thus, it has especially been proposed to use so-called “sacrificial agents”, which are chemical species supposed to have greater affinity for the rock than the surfactant species used for the enhanced oil recovery (e.g. lignosulfonates or sodium polyacrylate). Their efficacy is variable, especially depending on the nature of the surfactants, of the rock and of the salinity conditions.

Alternatively, alkali has been recommended to decrease the adsorption of anionic surfactants on rocks. The addition of alkali increases the pH and can make the surface charge negative which lead to a significant decrease in adsorption of anionic surfactant.

Alternatively, another contemplated solution for reducing the surfactant adsorption is the use of a salinity gradient. This salinity gradient strategy typically consists in a two-steps injection method where the brine initially in the subterranean formation (either the formation brine or a former injected brine), is progressively replaced by: 1) a surfactant slug and 2) an aqueous post-flush at a lower salinity. The surfactant slug containing is preferably in Winsor III condition, in a higher salinity environment, leading to an increased retention/adsorption of chemicals. Conversely, the aqueous post-flush will displace the surfactant slug with a lower salinity, shifting phase diagram from Winsor III to Winsor I, leading to a decreased adsorption and more favorable partitioning of the chemicals in brine. As a result, adsorption is significantly lower and chemicals trapped at the first front might be available at the second front leading to an additional oil mobilization and consequently an increase in oil recovery.

Salinity gradient or addition of alkali needs additional water treatment facilities. Besides, alkali addition may further create inorganic mineral deposition issue in reservoir and topside surface facility.

Chelating agents such as EDTA have also been proposed but they are however less cost effective as this process required at much higher concentrations to prevent surfactant adsorption on porous media.

More recently, the use of ethoxylated nonionic surfactants, such as Rhodasurf® LA 12 available from the company Solvay, which make it possible to effectively overcome the harmful effects of the retention of anionic surfactants in oil reservoirs, has been proposed, especially in application FR 2 986 008.

One aim of the present invention is to provide an efficient means for limiting or even overcoming the harmful effects of the retention of anionic surfactants in oil reservoirs during steps of enhanced oil recovery, most particularly in clay containing formation namely on rocks containing clays, especially on high clay containing rocks.

To this end, it is proposed according to the present invention to make use of a specific water-soluble non-ionic polymeric surfactant of the class of the polyoxopolyamines

### SUMMARY

More precisely, according to a first aspect, one subject-matter of the present invention is the use of at least one compound of formula (I) below:

R¹R²N—(CH₂)ₘ—NR³—(CH₂)_{m′}—NR⁴R⁵ Formula (I)

wherein

m and m′ are preferably identical, and each of m and m′ is 1, 2, 3 or 4; and R¹, R², R³, R⁴and R⁵ are distinct or the same, and each of R¹, R², R³, R⁴ and R⁵ is a group of formula —[O—CH₂—CH(—CH₃)—]ₙ—[O—CH₂—CH₂—]ₚ—OH, wherein n is from 2 to 30; and p is from 5 to 50

for decreasing or inhibiting the anionic-surfactant retention phenomena in an oil reservoir (the notion of “anionic surfactants” employed here in the plural refers equally to a population of at least one surfactant, namely either a plurality of anionic surfactants of one and the same type or a mixture of several types of anionic surfactants).

The compounds of formula (I) are preferably compounds wherein:
m=m′=2; or
m=2 and m′=3; or
m=m′=3; or
m=3 and m′=4
According to an advantageous embodiment, m=m′=2

According to an interesting embodiment, the compound of formula (I) used according to the invention is a compound wherein R¹, R², R³, R⁴ and R⁵ are the same. Typically, in that case, the compounds may have the formula (Ia) below:

RRN—CH₂—CH₂—NR—CH₂—CH₂—NRR formula (Ia)

wherein R is a group of formula —[—O—CH₂—CH(—CH₃)—]ₙ—[—O—CH₂-CH2—]ₚ—OH, wherein n is from 2 to 30; and p is from 5 to 50.

A good example of a compound of formula (I) useful according to the instant invention is diethylenetriamine pentakis (ethoxylate-block-propoxylate) pentol, namely a compound of formula (Ia) wherein n=12 and p=22.

Among suitable compounds of formula (I), reference may especially made to the commercial product Geronol® CF130 available from the Solvay company.

The studies performed by the inventors in the context of the present invention have now made it possible to reveal that the abovementioned compounds of formula (I) (and especially compounds of formula Ia) are water-soluble agents that have the particularly advantageous property of quantitatively desorbing anionic surfactants when they are injected in aqueous solution into rocks (oil reservoirs) into which these anionic surfactants have previously been adsorbed, even at high temperatures. In that sense, the compounds of formula (I) may be termed anionic surfactant desorbents.

The compounds of formula (I) may be used as anionic-surfactant desorbents without having to make use of any salinity gradient. For example, the compounds of formula (I) may be used in a process including two subsequent injections at the same salinity of: 1) an anionic surfactant containing slug having a given salinity and 2) a post-flush containing the compound of formula (I) and having the same salinity. In this scope, the compound of formula (I) mimics the salinity gradient effect induced in the salinity gradient strategies of the prior art, by reducing surfactant rock interactions and by decreasing partitioning into the oil phase, but without having to manage the technical issues linked to a salinity change.

The compounds of formula (I) make it especially possible to desorb in a particularly efficient manner anionic surfactants of sulfate and/or sulfonate and/or carboxylate type from oil-yielding rocks, especially mixtures of primary surfactants of olefin sulfonate or alkylarylsulfonate type and secondary surfactants of alkyl ether sulfate or alkyl glyceryl ether sulfonate or styrylphenol alkoxy sulfate type.

More generally, the compounds of formula (I) can desorb the majority of the anionic surfactants used for enhanced oil recovery, especially anionic surfactants of, phosphate and/or phosphonate type.

For the purposes of the present invention, the notion of anionic surfactant encompasses all surfactants bearing at least one anionic group under the conditions of the extraction performed. Thus, an anionic surfactant encompasses not only the abovementioned sulfates and sulfonates, but also other types of surfactants, including surfactants of zwitterionic nature. The compounds of formula (I) are particularly suited to the desorption of purely anionic surfactants (namely surfactants bearing not bearing positive charges). This being the case, according to a specific embodiment, the compounds of formula (I) may optionally be used for desorbing compounds of zwitterionic nature (alone or mixed with purely anionic surfactants).

The compounds of formula (I) make it especially possible to desorb:
Sulfonate anionic surfactants such as:
   alkylarylsulfonates, notably alkyl benzene sulfonate (ABS), wherein the alkyl group preferably contains at least 15 carbon atoms, for example between 15 and 24, for example an ABS having a C15-18 alkyl group
   internal olefin sulfonates, preferably C15 to C28, e.g. C20-24, internal olefin sulfonate
   mono and/or bis-sulfonates of alpha-sulfocarbonyl compounds such as those described for example in WO 2016/177817, notably monosulfonates and disulfonates derivated from C15-C35 internal ketones
   sulfosuccinates and sulfosuccinamates
alkyl glyceryl ether sulfonates (AGES), wherein the alkyl group preferably comprises at least 10 carbon atoms, for example between 10 and 16 carbon atoms, said AGES being preferably propoxylated and/or ethoxylated, for example comprising from 0 to 40 ethoxy and from 0 to 20 propoxy (with at least one ethoxy or propoxy being present);
alkyl ether sulfates (AES, also called alkoxylated alkyl sulfates), wherein the alkyl group preferably includes at least 10 carbon atoms, for example from 10 to 16, e.g. propoxylated and/or ethoxylated alkyl ether sulfates having up to 40 ethoxy groups and/or up to 20 propoxy groups, for example from 0 to 40 ethoxy and 0 to 20 propoxy (with at least one ethoxy or propoxy being present);
alkyl ether carboxylates, preferably propoxylated and/or ethoxylated, for example comprising from 0 to 40 ethoxy and from 0 to 20 propoxy (with at least one ethoxy or propoxy being present)
styryl phenol alkoxylate sulfate; preferably propoxylated and/or ethoxylated, for example comprising from 0 to 40 ethoxy and from 0 to 20 propoxy (with at least one ethoxy or propoxy being present)
styryl phenol alkoxylate phosphate preferably propoxylated and/or ethoxylated, for example comprising from 0 to 40 ethoxy and from 0 to 20 propoxy (with at least one ethoxy or propoxy being present).
mixtures of these surfactants.

### DETAILED DESCRIPTION

According to a specific embodiment, corresponding to the attached examples, the compound of formula (I) may e.g. be used for desorbing a mixture of ABS and AGES.

The compounds of formula (I) significantly reduce the adsorption of surfactants, especially of the abovementioned type, i.a. in clay-containing rocks, especially in high clay containing rocks. Oil reservoir comprising such rocks are suitable for the invention.

It furthermore turns out that these various properties are obtained both at low contents of salts and of divalent cations and at a high content of these salts or cations (especially by using seawater as solvent for the surfactants), this also being achieved in rocks of carbonate or argillaceous sandstone type.

Furthermore, the effects observed in the context of the present invention do not involve high concentrations of compound of formula (I). Typically, in the context of the present invention, the compounds of formula (I) are used—alone or in the form of a mixture of several nonionic surfactants of formula (I)—in aqueous fluids comprising these compounds at a total concentration that does not need to exceed 5 g/L, and which may be, for example, between 0.1 and 4 g/L, preferably between 0.5 and 2 g/L.

Besides the abovementioned advantages, the compounds of formula (I) that are useful according to the invention may, at least in certain cases, improve the water solubility of anionic surfactants, especially of sulfate or sulfonate type. The compounds of formula (I) make it possible in this respect to improve the injectivity of certain anionic surfactants, especially mixtures of primary surfactants of olefin sulfonate or alkylarylsulfonate type and secondary surfactants of alkyl ether sulfate or sulfonate type, when they are added in combination with these surfactants.

According to an advantageous embodiment, the compounds of formula (I) are used in combination with at least one polymer, especially a viscosity-enhancing polymer. According to this embodiment, the inhibiting effect on the anionic-surfactant retention or desorption phenomena generally proves to be most particularly advantageous.

The compounds of formula (I) may especially be used in combination with viscosity-enhancing polymers chosen from:
hydrophilic polymers including homopolymers, copolymers or terpolymers, for instance polymers of modified or unmodified alkyl acrylate type, optionally bearing substituents such as 2-acrylamido-2-methylpropanesulfonic acid, N,N-dimethylacrylamide, vinylpyrrolidone, dimethylaminoethyl methacrylate, acrylic acid, vinyl acetate, vinylsulfonic acid or methacrylic acid groups.
biopolymers such as guars or xanthan gum or scleroglucan, for example.

Preferably, the above mentioned compounds of formula (I), whatever their exact formula, are used for decreasing or inhibiting the retention phenomena of anionic surfactants chosen from:
anionic agents of sulfonate and/or sulfate type;
mixtures of anionic surfactants comprising one or more anionic agents of sulfonate and/or sulfate type, these mixtures preferably not comprising nonionic surfactants.

Preferably, the compounds of formula (I) are used as anionic-surfactant desorbents.

According to a more specific aspect, a subject of the present invention is processes for enhanced oil recovery (EOR) from an underground formation, which makes use of at least one of the abovementioned uses of the compounds of formula (I) for decreasing or inhibiting the retention phenomena of anionic surfactants used during said process, the compound of formula (I) preferably being at least used as anionic-surfactant desorbent.

Thus, according to a first, particularly advantageous embodiment, a subject of the present invention is especially a process of enhanced oil recovery from an underground formation, wherein:
a first fluid comprising at least an aqueous medium, an anionic surfactant and optionally an additional anionic surfactant, called anionic cosurfactant (this first fluid advantageously being able to comprise a polymer, especially a partially hydrolyzed polyamide) is injected into said underground formation, via at least one injection well; and then
a second fluid comprising a compound of formula (I) of the abovementioned type is subsequently injected via the same injection well(s); and
a fluid conveying the oil leaving the underground formation is recovered by at least one production means.

According to another embodiment which is compatible with the preceding embodiment, a subject of the present invention is a process of enhanced oil recovery from an underground formation, wherein:
a first fluid comprising at least an aqueous medium, a compound of formula (I) of the abovementioned type, an anionic surfactant and optionally an anionic cosurfactant (this fluid typically being able to comprise a polymer, especially a partially hydrolyzed polyamide) is injected into said underground formation, via at least one injection well; and then
a fluid conveying the oil leaving the underground formation is recovered by at least one production means.

According to yet another advantageous embodiment, optionally compatible with one of the preceding embodiments and/or the other, a subject of the present invention is a process of enhanced oil recovery from an underground formation, in which:
a first fluid comprising a compound of formula (I) of the abovementioned type is injected into said underground formation, via at least one injection well; and then
a second fluid comprising at least an aqueous medium, an anionic surfactant and optionally an anionic cosurfactant (this second fluid typically being able to comprise a polymer, especially a partially hydrolyzed polyamide) is introduced; and then
a fluid conveying the oil leaving the underground formation is recovered by at least one production means.

The above variants of the processes of the invention are compatible. According to a specific variant, a subject of the present invention is a process of enhanced oil recovery from an underground formation, in which:
a first fluid comprising at least an aqueous medium, a compound of formula (I) of the abovementioned type, an anionic surfactant and optionally an anionic cosurfactant (this fluid typically being able to comprise a polymer, especially a partially hydrolyzed polyamide) is injected into said underground formation, via at least one injection well; and then
a second fluid comprising a compound of formula (I) of the abovementioned type is subsequently injected via the same injection well(s); and
a fluid conveying the oil leaving the underground formation is recovered by at least one production means.

The different variants of the processes of the invention may be advantageously used for the enhanced recovery of oil in underground formations which are consolidated or non-consolidated, carbonate-based or argillaceous (especially argillaceous sandstone) rocks. Be that as it may, the invention shall not be limited solely to such reservoirs.

The examples below illustrate a non-limiting embodiment of the invention and advantages relating to the compounds of formula (I).

### EXAMPLES

This example illustrates the effect of compounds of formula (I) on the reduction of the adsorption of an anionic surfactant formulation (mixture of two anionic surfactants, namely an ABS (alkyl benzyl sulfonate Soloterra 117H from Sasol) and an AGES containing 3 propoxy groups and 12 ethoxy groups from Solvay.

Static adsorption testing was performed using first a crushed rock sample which has significantly high content of clay. The rock sample was made of predominantly of quartz mineral with ˜20% clay in the form of illite, kaolinite, smectite, chlorite notably.

The surfactant mixture was used in the form of an aqueous solution of concentration 2 g/L (lg/L of each of the surfactants) and Geronol® CF130 from Solvay was added to the solution (1 g/L). The obtained mixture was stirred overnight in contact with 1 g of crushed rock at 25° C. to allow sufficient contact time for surfactant adsorption on the rock.

Hyamine titration was applied to determine the surfactant loss after filtration of the solution from the rock sample.

A control batch of rock and surfactant (ABS 117H+AGES 3 PO 12EO) without any compound of formula (I) was used as a reference for calculating the percentage (%) inhibition considering 0% inhibition in control sample.

The % inhibition obtained with 1 g/L Geronol® CF130 was of 60% which is an especially high % inhibition: as a comparison the inventors tested a great number of compounds not matching formula (I), especially oleyl alcohol ethoxylates, alkoxylated carboxymate, alkylpolyglucosides. For all these compounds, the measured % inhibition was between −10 and +11%.

The result was further validated using HPLC technique for measuring the concentration of free surfactant (the area under the HPLC peak is directly proportional to concentration of the surfactant present in the solution), with various concentration of Geronol® CF130. HPLC results confirm those of the hyamine titration and even show that more than 80% inhibition in the static testing can be achieved while Geronol® CF130 is used at 2 g/L.

The results obtained are reported in Table 1 below.

TABLE 1
HPLC results for reservoir rock (~20% clay) as previously described

| Concentration of | | |
|---|---|---|
| Geronol ® CF130 (g/l) | Adsorption (mg/g) | % inhibition |
| 0 | 10 | 0% |
| 1 | 3.6 | 64% |
| 2 | 1.6 | 84% |

Complementary static adsorption testing were performed using the same formulation and salinity conditions as described above but with crushed rock samples obtained from Clashach and Berea rocks. The results obtained are reported in Table 2 below.

TABLE 2
HPLC results for 3 different reservoir rock: Clashach,
Bera and reservoir rock with a high clay content (~20% clay)

| | conc of | | |
|---|---|---|---|
| | Geronol | Adsorption | |
| ROCK | CF130 g/L | mg/gm | % inhibition |
| Clashach | | 1.4 | 0% |
| | 0.5 g/L | 0.10 | 92% |
| | 1.0 g/L | 0.050 | 97% |
| | 2.0 g/L | 0.030 | 98% |
| Berea | | 2.5 | 0% |
| | 0.5 g/L | 1.0 | 60% |
| | 1.0 g/L | 1.1 | 57% |
| | 2.0 g/L | 0.95 | 62% |
| Rock | | 10 | 0% |
| with high | 0.5 g/L | 4.5 | 55% |
| clay | 1.0 g/L | 3.6 | 64% |
| (~20%) | 2.0 g/L | 1.65 | 84% |

1. A method comprising injecting at least one compound having the formula (I) below:
R¹R²N—(CH₂)ₘ—NR³—(CH₂)_{m′}—NR⁴R⁵ Formula (I)
wherein:
each of m and m′ is 1, 2, 3 or 4; and
each of R¹, R², R³, R⁴ and R⁵, identical or different, is a group of formula —[O—CH₂—CH(—CH₃)—]ₙ—[O—CH₂—CH₂—]ₚ—OH, wherein n is from 2 to 30; and p is from 5 to 50
into an oil reservoir.

2. The method of claim 1, wherein m=m′=2.

3. The method of claim 2, wherein the compound of formula (I) has the formula below:
RRN—CH₂—CH₂—0NR—CH₂—CH₂—NRR formula (Ia)
wherein R is a group of formula —[—O—CH₂—CH(—CH₃)—]ₙ—[—O—CH₂—CH₂—]ₚ—OH, wherein n is from 2 to 30; and p is from 5 to 50.

4. The method of claim 3, wherein n=12 and p=22.

5. The method of claim 1, wherein the anionic surfactant is selected from:
Sulfonate anionic surfactants selected from the group consisting of:
alkylarylsulfonates,
internal olefin sulfonates,
mono and/or bis-sulfonates of alpha-sulfocarbonyl compounds, and
sulfosuccinates and sulfosuccinamates;
alkyl glyceryl ether sulfonates (AGES);
alkyl ether sulfates (AES);
alkyl ether carboxylates;
styryl phenol alkoxylate sulfate;
styryl phenol alkoxylate phosphate;
mixtures of these surfactants.

6. The method of claim 1, wherein the oil reservoir comprises clay-containing rocks.

7. The method of claim 1, wherein the compound of formula (I) is used alone or in the form of a mixture of several compounds of formula (I), in an aqueous fluid having a total concentration of compounds of formula (I) of less than 5 g/L.

8. The method of claim 1, wherein the compound of formula (I) is used in combination with at least one polymer.

9. A method comprising injecting at least one of compound of formula (I) as defined in claim 1 into an underground formation.

10. The method of claim 9, wherein:
a first fluid comprising at least an aqueous medium, an anionic surfactant and optionally an additional anionic surfactant and optionally a polymer, is injected into said underground formation, via at least one injection well; and then
a second fluid comprising a compound of formula (I) as defined in claim 1 is subsequently injected via the same injection well(s); and
a fluid conveying the oil leaving the underground formation is recovered by at least one production means.

11. The method of claim 9, wherein:
a first fluid comprising at least an aqueous medium, a compound of formula (I) as defined in claim 1, an anionic surfactant, and optionally an anionic cosurfactant and optionally a polymer, is injected into said underground formation, via at least one injection well; and then
a fluid conveying the oil leaving the underground formation is recovered by at least one production means.

12. The method of claim 9, wherein:
a first fluid comprising a compound of formula (I) as defined in claim 1 is injected into said underground formation, via at least one injection well; and then
a second fluid comprising at least an aqueous medium, an anionic surfactant and optionally an anionic cosurfactant and optionally a polymer is introduced; and then
a fluid conveying the oil leaving the underground formation is recovered by at least one production means.

13. The method of claim 10, wherein:
a first fluid comprising at least an aqueous medium, a compound of formula (I) as defined in claim 1, an anionic surfactant and optionally an anionic cosurfactant (this fluid typically being able to comprise a polymer, especially a partially hydrolyzed polyamide) is injected into said underground formation, via at least one injection well; and then
a second fluid comprising a compound of formula (I) as defined in claim 1 is subsequently injected via the same injection well(s); and
a fluid conveying the oil leaving the underground formation is recovered by at least one production means.

14. The method of claim 5, wherein the anionic surfactant is alkyl benzene sulfonate (ABS).

15. The method of claim 14, wherein the alkyl group contains at least 15 carbon atoms.

16. The method of claim 5, wherein the mono and/or bis-sulfonates of alpha-sulfocarbonyl compounds are monosulfonates and disulfonates derived from C15-C35 internal ketones.

17. The method of claim 5, wherein the anionic surfactant is an alkyl glyceryl ether sulfonate (AGES), wherein the alkyl group comprises at least 10 carbon atoms.

18. The method of claim 5, wherein the anionic surfactant is an alkyl ether sulfate (AES), wherein the alkyl group includes at least 10 carbon atoms.

19. The method of claim 7, wherein the total concentration of compounds of formula (I) is between 0.1 and 4 g/L.

20. The method of claim 8, wherein the at least one polymer is a viscosity-enhancing polymer.
